(19) United States
(12) Patent Application Publication
(10) Pub. No.: US 2010/0038123 A1
(43) Pub. Date: Feb. 18, 2010

(54) BOARD UNIT AND MANUFACTURING METHOD FOR THE SAME

(75) Inventor: Takahiro KITAGAWA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/500,585

(22) Filed: Jul. 9, 2009

(30) Foreign Application Priority Data
Aug. 14, 2008 (JP) 2008-209010

(51) Int. Cl. H01R 12/04; B23K 31/02

(52) U.S. Cl. 174/261; 228/165; 174/260

(57) ABSTRACT

A board unit includes an electronic component having electrodes; a printed circuit board that has board electrodes each disposed at a position corresponding to a respective one of the electrodes, and that mounts thereon the electronic component; recesses each arranged from the center of a respective one of the board electrodes toward the inside thereof; and joining members that are filled in the respective recesses, and that project from the respective board electrodes upon being heated.

### CROSS-REFERENCE TO RELATED APPLICATIONS

This application is based upon and claims the benefit of priority of the prior Japanese Patent Application No. 2008-209010, filed on Aug. 14, 2008, the entire contents of which are incorporated herein by reference.

### FIELD

The embodiments discussed herein are related to a board unit to which an electronic component is solder-connected, and relates to manufacturing method for the board unit.

### BACKGROUND

With the miniaturization and the densification of electronic devices, enhancement of mounting density in mounting electronic components on a printed circuit board has been desired. For this purpose, the so-called ball grid array (BGA) mounting method by which grid-shaped solder balls arranged on a mounting surface of electronic components are jointed to board electrodes formed on a printed circuit board is being performed. In the electronic devices miniaturized and densified as described above, board electrodes for mounting electronic components are also miniaturized and densified, correspondingly.

Conventionally, the joining between the electronic component and the board electrodes has been performed as follow: when the electronic component is positioned, solder is printed on surfaces of the board electrodes, and after solder balls on the electronic device side have been temporarily fixed on a printed circuit board making use of adhesiveness of the printed solder, the solder balls are heated above their melting point in a reflow furnace for melting. Thereafter, the solder balls are cooled down to a room temperature, thereby achieving joining between the electronic component and the board electrodes (refer to, for example, Japanese Laid-open Patent Publication No. 10-313170).

FIG. 1 is an explanatory diagram of conventional joining between an electronic component and a printed circuit board. This is an example wherein there has been occurred warpage of an electronic component 61 with respect to a printed circuit board 51. In order to join electrodes (not illustrated) on an electronic component 61 and board electrodes 52 on the printed circuit board 51, respectively, via the solder balls 62 and the printing solder 53, the printed circuit board 51 to which the electronic component 61 has been temporarily adhered is put into a reflow furnace for heating. At this time, if there is a difference in thermal expansion coefficient between the printed circuit board 51 and the electronic component 61, warpage occurs. Since this warpage generates a gap between the electronic component 61 and the printed circuit board 51, there occur portions not allowing joining between the board electrodes 52 on the printed circuit board 51 and the electrodes on the electronic component 61, resulting in joining failure.

### SUMMARY

According to an aspect of the invention, a board unit includes an electronic component having an electrode; a printed circuit board having a board electrode disposed at a position corresponding to the electrode, and mounting the electronic component; a recess arranged from the center of the board electrode toward the inside of the printed circuit board; and a joining member filled in the recess, and projecting from the board electrode upon being heated.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of conventional joining between an electronic component and a printed circuit board;

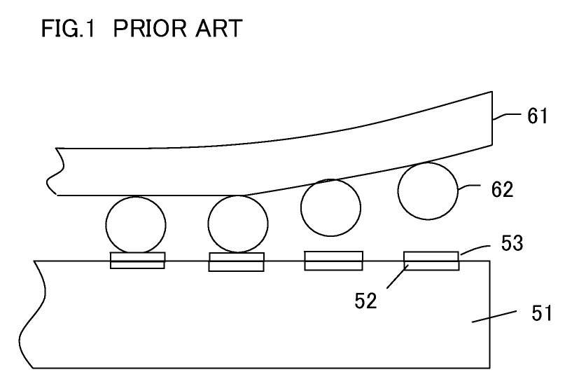

FIG. 2 is a brief explanatory diagram of embodiment of joining between the electronic component and the printed circuit board;

FIG. 3 is an explanatory diagram of a board unit according to a first embodiment;

FIGS. 4A and 4B are explanatory diagrams of the filling of a gap between the electronic component and the printed circuit board;

FIG. 5 is schematic diagram illustrating procedures of the manufacturing of the board unit by soldering;

FIG. 6 is a graph illustrating a relationship between the volume of solder and the height thereof;

FIGS. 7A to 7E are diagrams of manufacturing processes of a board according to the first embodiment.

FIG. 8 is an explanatory diagram of a board unit according to a second embodiment;

FIGS. 9A to 9D are diagrams illustrating manufacturing processes of a board according to the second embodiment;

FIG. 10 is an explanatory diagram of a board unit according to a third embodiment;

FIGS. 11A to 11D are diagrams of manufacturing processes of a board according to the third embodiment;

FIG. 12 is an explanatory diagram of a board unit according to a fourth embodiment;

FIG. 13 is an explanatory diagram of a board unit according to a fifth embodiment; and

FIG. 14 is an explanatory diagram of a board unit according to a sixth embodiment.

### DESCRIPTION OF EMBODIMENTS

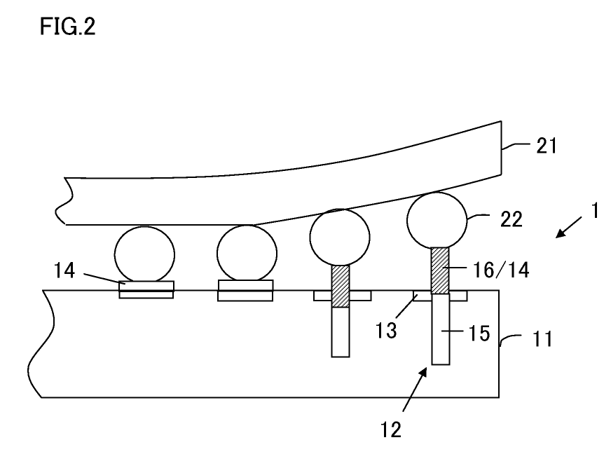

FIG. 2 illustrates a brief embodiment of joining between an electronic component and a printed circuit board.

The board unit 1 includes an electronic component 21 and a printed circuit board 11. Cylindrical-shaped joining member accommodation holes 12 are each arranged from the center of the board electrode 13 on the printed circuit board 11 toward the inside of the printed circuit board 11. A joining member is filled in each of the joining member accommodation holes 12 as a recess. FIG. 2 illustrates the case wherein, as joining members, filling solder 16 is filled in an upper portion of each of the joining member accommodation holes 12 and a thermal expansion material 15 is filled in the lower portion of each of them. If a warpage amount of the electronic component 21 in the soldering process is known in advance, the joining member accommodation holes 12 in conformance with the warpage amount of the electronic component 21 are arranged as illustrated in FIG. 2. If the warpage amount of the electronic component 21 is partially unknown, or if printing solder 14 is not provided, the joining member accommodation holes 12 are provided to all the board electrodes 13.

When the board unit is put into a reflow furnace for heating, there occurs a gap between the electronic component 21 and the printed circuit board 11 due to warpage of the electronic component 21 and the like. However, the joining member projects from the board electrodes 13 due to its thermal expansion, so that electrodes (not illustrated) on the electronic component 21 and the board electrodes 13 on the printed circuit board 11 join together.

In the example in FIG. 2, due to thermal expansion of the thermal expansion material 15 serving as the joining member, filling solder 16 serving as the joining member projects from the board electrodes 13, and joins with the solder balls 22 connected to the electrodes (not illustrated) on the electronic component 21, together with the printing solder 14. The use of such a structure of the printed circuit board 11 allows reliable joining between the electrodes (not illustrated) on the electronic component 21 and the board electrodes 13 on the printed circuit board 11.

Hereinafter, embodiments will be described with reference to the appended drawings in detail. Through these drawings, the same or equivalent components are designated by the same reference numerals, and redundant description is avoided.

### First Embodiment

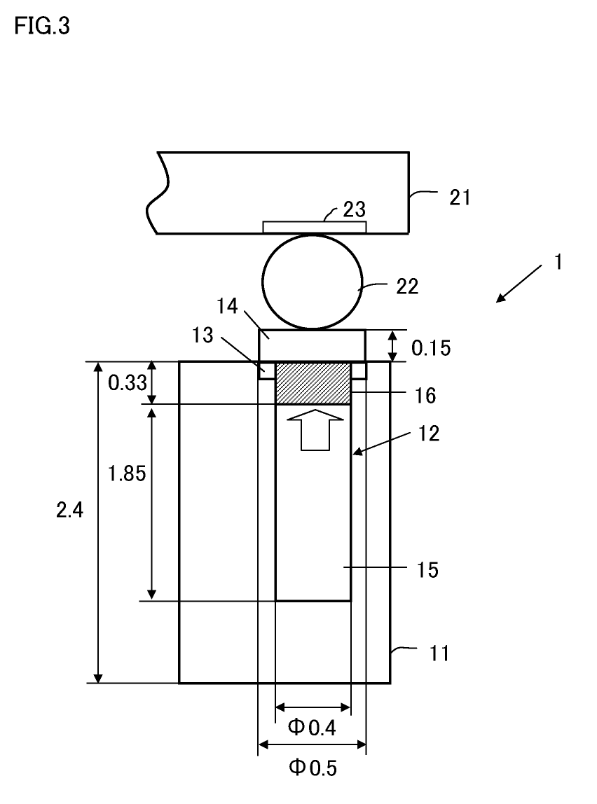

FIG. 3 is explanatory view of a board unit 1 according to a first embodiment. The board unit 1 includes the electronic component 21 and the printed circuit board 11. FIG. 3 illustrates a state of the board unit 1 before being subjected to reflow.

(1) Description of Structure of Board:

In FIG. 3, a partially enlarged sectional view of one portion of the printed circuit board 11 is illustrated. The printed circuit board 11 is made of glass epoxy resin. The printed circuit board 11 has, for example, a width of 210 mm, a depth of 300 mm, and a thickness of 2.4 mm. Because of this thickness value, warpage of the printed circuit board 11 hardly occurs.

Each of the joining member accommodation holes 12 as a recess is assumed to be a cylindrical hole, for example, having a diameter of 0.4 mm and a depth of 2.18 mm. The hole is a non-through hole formed from the center of each of the board electrodes 13 toward the inside of the printed circuit board 11. Each of the joining member accommodation holes 12 accommodates the thermal expansion material 15 in its lower portion, and the filling solder 16 in its upper portion, each as the joining member.

Each of the board electrodes 13 is made of Cu plating having a diameter of 0.5 mm, and formed in a portion corresponding to a respective one of the solder balls 22 on the electronic component 21.

The printing solder 14 as a solder member is Sn—Ag—Cu-based solder having a melting point of 220° C. The printing solder 14 has a diameter of 0.5 mm and a height of 0.15 mm, thus occupying a volume of 0.029 mm³. The flux content of the printing solder 14 is about 12 weight percent. The thermal expansion material 15 is made of, for example, an epoxy-based underfill material. The thermal expansion material 15 has a diameter of 0.4 mm and a height of 1.85 mm, thus occupying a volume of 0.23 mm³. The linear expansion coefficient of the thermal expansion material 15 is 300 ppm/° C. The filling solder 16 is Sn—Ag—Cu-based solder having a melting point of 220° C. The filling solder 16 has a diameter of 0.4 mm and a height of 0.33 mm, thus occupying a volume of 0.042 mm³. The flux content of the filling solder 16 is about 12 weight percent.

(2) Description of Electronic Component:

In FIG. 3, a partially enlarged section of one portion of the electronic component 21 is illustrated. The electronic component 21 is, for example, of a surface-mounting BGA (ball grid array) type. This is an example wherein a ball-shaped solder ball 22 is formed in advance on an electrode 23. The solder ball 22 is an Sn—Ag—Cu-based solder having a melting point of 220° C. The diameter of the solder ball 22 is assumed to be, for example, 0.5 mm. The electronic component 21, for example, has dimensions of a width of 33 mm, a depth of 33 mm, and a height of 2.3 mm.

In the joining between the printed circuit board 11 and the electronic component 21, because there is a difference in thermal expansion therebetween, warpage occurs at joint portions therebetween, and a gap arises between the solder balls 22 and the printing solder 14. The dimension of this gap is, for example, 0.3 mm. In order to fill the gap, the joining member accommodation holes 12 are disposed at places where joining failure to occur, to thereby perform reinforcement of the joining. Each of the joining member accommodation holes 12 accommodates the thermal expansion material 15 in its lower layer portion, and the filling solder 16 in its upper layer portion. As a result, the filling solder 16 is pushed up by thermal expansion of the thermal expansion material 15.

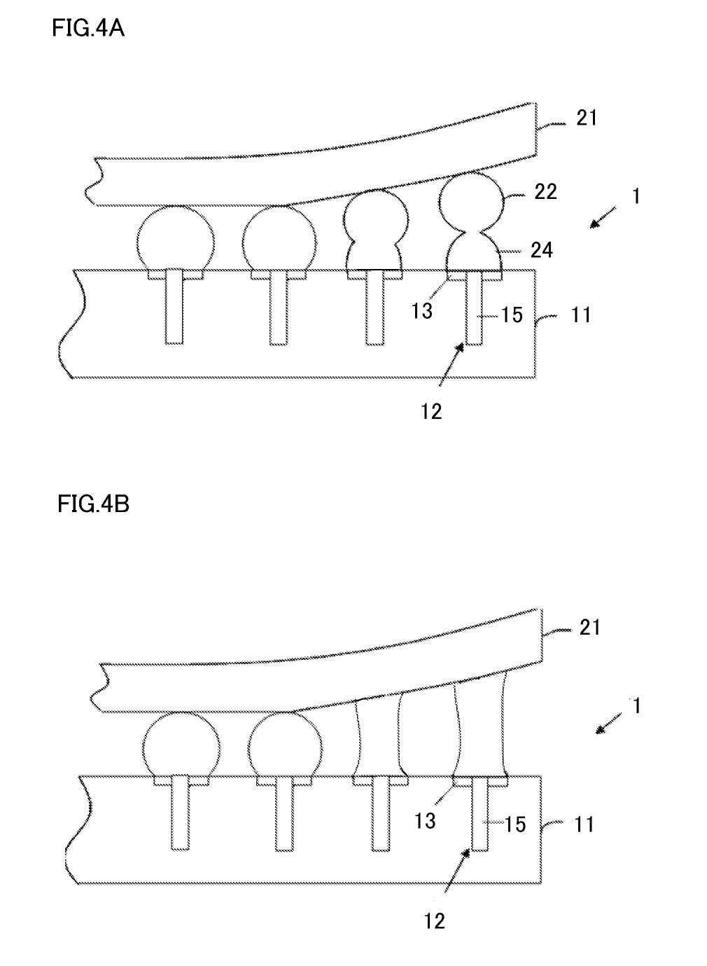

FIGS. 4A and 4B are explanatory diagrams of the filling of a gap between the electronic component and the printed circuit board. Here, the electrode 23 of the electronic component 21 is omitted from illustration.

FIG. 4A illustrates a state wherein the filling solder 16 and the printing solder 14 melt together into a single solder ball 24, and are in contact with the solder balls 22 on the electronic component 21. Thereafter, as illustrated in FIG. 4B, the solder ball 24 and the solder balls 22, which have merged together, assume a pillar shape or a ball-shape due to a surface tension, thus completing the joining between the electronic component 21 and the printed circuit board 11.

(3) Description of Joining Processing:

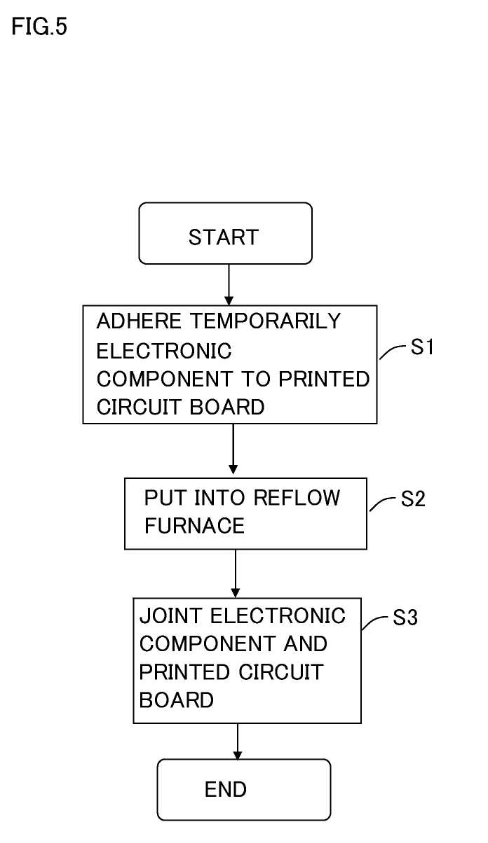

In FIG. 5, schematic diagram illustrating procedures of the manufacturing of the board unit by soldering is illustrated. The described schematic procedures are common to all embodiments.

(a) First, the electronic component 21 is mounted onto the printing solder 14 on the board electrodes 13 of the printed circuit board 11 while being aligned with the printing solder 14 using the solder balls 22.

(b) The solder balls 22 on the electronic component 21 are temporarily adhered to the printed circuit board 11 by the printing solder 14 (step S1).

(c) Next, the printed circuit board 11 with the electronic component 21 mounted thereon has been mounted, is put into a reflow furnace (step S2)

(d) By performing the heating up to 220° C. in the reflow furnace, the electronic component 21 and the printed circuit board 11 thermally expand, thereby causing warpage to the electronic component 21. As a result, a gap occurs between the solder balls 22 and the printing solder 14. Furthermore, the solder balls 22, the printing solder 14, and the filling solder 16 each melt.

(e) On the other hand, the thermal expansion material 15 increases in volume due to its thermal expansion, to thereby push up the filling solder 16.

(f) The pushed-up filling solder 16 merges with the printing solder 14 by their melting-together, to thereby deform into a ball-like shape.

(g) The deformed ball-shaped solder assumes a height to fill in the gap of 0.3 mm between the electronic component 21 and the printed circuit board 11, so that the melted solder balls 22 on the electronic component 21 and the printing solder 14 join together (step S3).

(4) Description of Gap Filling Processing:

Operations for filling the gap of 0.3 mm are described below. (a) Since the linear expansion coefficient of the thermal expansion material 15 is 300 ppm/° C., its volume expansion coefficient is 900 ppm/° C. On the other hand, the temperature increase ΔT from a room temperature of 20° C. to 220° C. is 200° C. Accordingly, the volume expansion of the thermal expansion material 15 is obtained as follows: (900/106)×(volume of thermal expansion material 15: 0.23 mm³)×(temperature increase: 200)=0.042 mm³.

(b) On the other hand, the volume of the filling solder 16 is 0.042 mm³ as described above.

(c) Therefore, due to its thermal expansion, the thermal expansion material 15 pushes out the entire filling solder 16 up to the surface of the printed circuit board 11. However, this holds true only with the case wherein the volume expansion of the thermal expansion material 15 occurs entirely on the side of the filling solder 16.

(d) On the other hand, the volume of the pushed-out filling solder 16, i.e., 0.042 mm³ plus the volume of the printing solder 14, i.e., 0.029 mm³ is 0.071 mm³. However, since the volume decreases upon melting, the total volume of 0.071 mm³ decreases to 0.043 mm³.

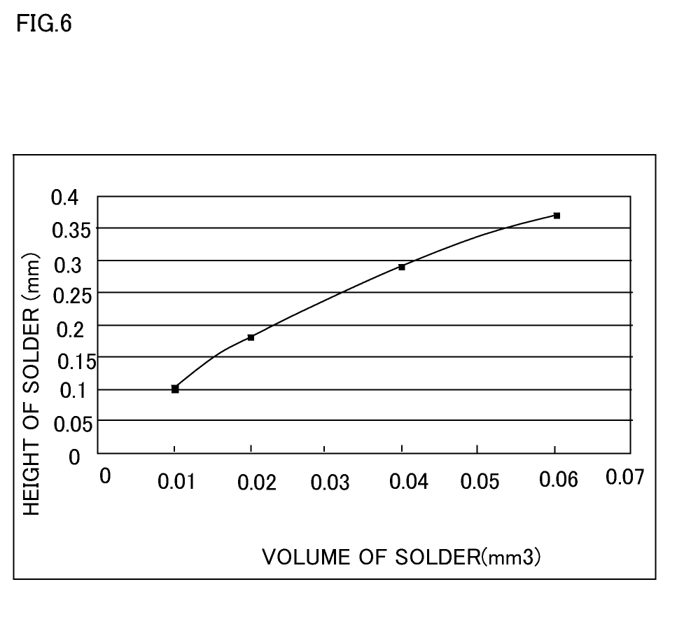

FIG. 6 illustrates relationships between the volume of solder and the height thereof. Here, the diameter of the board electrodes 13 is 0.5 mm. The horizontal axis designates the volume of melted solder, and the vertical axis designates the height of melted solder assuming a spherical shape due to its surface tension. Changes in the height of melted solder with respect to the volume thereof are as follows: 0.1 mm for 0.01 mm³, 0.18 mm for 0.02 mm³, 0.29 mm for 0.04 mm³, and 0.37 mm for 0.06 mm³. For the melted solder having a volume of 0.043 mm, as illustrated in FIG. 4A, the height of the solder ball excesses 0.3 mm. As a consequence, the joining between the electronic component 21 and the printed circuit board 11 can be established even though the gap has occurred therebetween.

(5) Description of Manufacturing Processes for Board in First Embodiment:

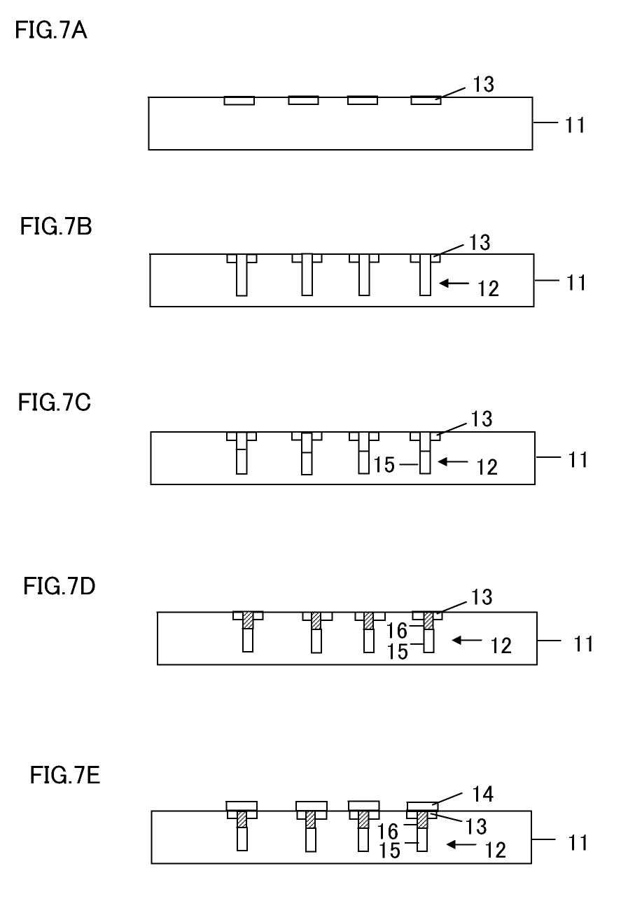

In FIGS. 7A to 7E, diagrams of manufacturing processes of a board according to the first embodiment are illustrated.

(a) A printed circuit board 11 on which the board electrodes 13 has been formed in advance is prepared (refer to FIG. 7A).

(b) Then, the joining member accommodation holes 12 are formed from the center of the board electrodes 13 toward the vertical direction by a drill (refer to FIG. 7B).

(c) Next, the thermal expansion material 15 is injected into each of the joining member accommodation holes 12 by a dispenser down to a distance of 1.85 mm from the bottom of each of the joining member accommodation holes 12 (refer to FIG. 7C).

(d) Then, the filling solder 16 is filled into the joining member accommodation holes 12, using a metal mask and a squeegee each having openings corresponding to the joining member accommodation holes 12 (refer to FIG. 7D).

(e) Thereafter, the printing solder 14 is applied to the board electrodes 13, using a metal mask and a squeegee each having openings corresponding to the board electrodes 13 (refer to FIG. 7E).

### Second Embodiment

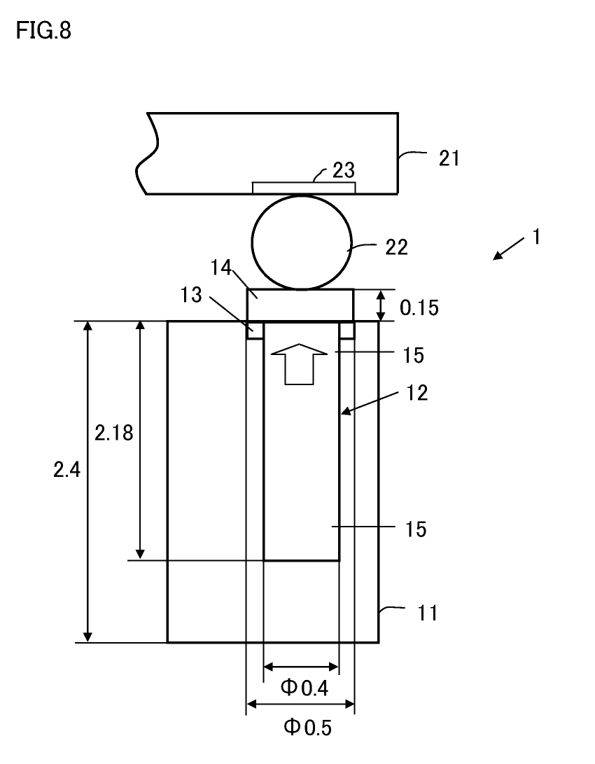

FIG. 8 is an explanatory view of a board unit 1 according to a second embodiment. The board unit 1 includes the electronic component 21 and the printed circuit board 11. FIG. 8 illustrates a state of the board unit 1 before being subjected to reflow.

(1) Description of Structure of Board:

In FIG. 8, a partially enlarged section of one portion of the printed circuit board 11 is illustrated. The printed circuit board 11, the joining member accommodation holes 12, the board electrodes 13, and the printing solder 14 in this embodiment are the same as those in the first embodiment. The second embodiment is different from the first embodiment in that, as the joining member, only the thermal expansion material 15 is accommodated in each of the joining member accommodation holes 12. The thermal expansion material 15 is made of, for example, a urethane-based underfill material. The thermal expansion material 15 has a diameter of 0.4 mm and a height of 2.18 mm, thus occupying a volume of 0.27 mm³. The linear expansion coefficient of the thermal expansion material 15 is 300 ppm/° C.

(2) Description of Electronic Component:

The structure of the electronic component 21 in this embodiment is the same as that in the first embodiment. Here shown is an example wherein, for example, a gap of 0.3 mm occurs between the electronic component 21 and the printed circuit board 11 due to a difference in thermal expansion therebetween. In order to fill the gap, the joining member accommodation holes 12 are disposed at places where joining failure to occur, to thereby perform reinforcement of the joining. The joining member accommodation holes 12 each accommodate the thermal expansion material 15. As a result, the printing solder 14 is pushed up by the expansion of the thermal expansion material 15, thereby joining the electronic component 21 and the solder balls 22 together.

(3) Description of Joining Processing:

(a) First, the electronic component 21 is mounted onto the printing solder 14 on the board electrodes 13 of the printed circuit board 11 while being aligned with the printing solder 14 using the solder balls 22.

(b) The solder balls 22 on the electronic component 21 are temporarily adhered to the printed circuit board 11 by the printing solder 14 (step S1 in FIG. 5).

(c) Next, the printed circuit board 11 with the electronic component 21 mounted thereon is put into a reflow furnace (step S2 in FIG. 5)

(d) By performing the heating up to 220° C. in the reflow furnace, the electronic component 21 and the printed circuit board 11 thermally expand, thereby causing warpage to the electronic component 21. As a result, a gap occurs between the solder balls 22 and the printing solder 14. Furthermore, the solder balls 22 and the printing solder 14 melt together.

(e) On the other hand, the thermal expansion material 15 increases in volume due to its thermal expansion, to thereby push up the printing solder 14.

(f) The pushed-up printing solder 14 deforms into a ball-like shape due to melting.

(g) The deformed ball-shaped solder assumes a height to fill in the gap of 0.3 mm between the electronic component 21 and the printed circuit board 11, so that the solder balls 22 melted on the electronic component 21 and the printing solder 14 join together (step S3 in FIG. 5).

(4) Description of Gap Filling Processing:

Operations for filling the gap of 0.3 mm are described below. (a) Since the linear expansion coefficient of the thermal expansion material 15 is 300 ppm/° C., its volume expansion coefficient is 900 ppm/° C. On the other hand, the temperature increment ΔT from a room temperature of 20° C. to 220° C. is 200° C. Therefore, the volume expansion of the thermal expansion material 15 is obtained as follows: (900/106)×(volume of thermal expansion material 15: 0.27 mm³)×(temperature increment: 200)=0.049 mm³.

(b) That is, the thermal expansion material 15 expands by 0.049 mm³ due to its thermal expansion.

(c) The expanded thermal expansion material 15 pushes up the printing solder 14. The volume of the printing solder 14 after melting, i.e., 0.018 mm³ plus the volume expansion amount of the thermal expansion material 15, i.e., 0.049 mm³ is 0.067 mm³. The printing solder 14, having a very high surface tension, forms into a ball shape. Upon forming into a ball shape, the printing solder 14 assumes a height up to its top exceeding 0.3 mm, as illustrated in FIG. 6. As a consequence, the joining between the electronic component 21 and the printed circuit board 11 can be established even though the gap has occurred between electronic component 21 and the printed circuit board 11. Meanwhile, as the thermal expansion material 15 in the second embodiment, air may be used instead.

(5) Description of Manufacturing Processes for Board in Second Embodiment:

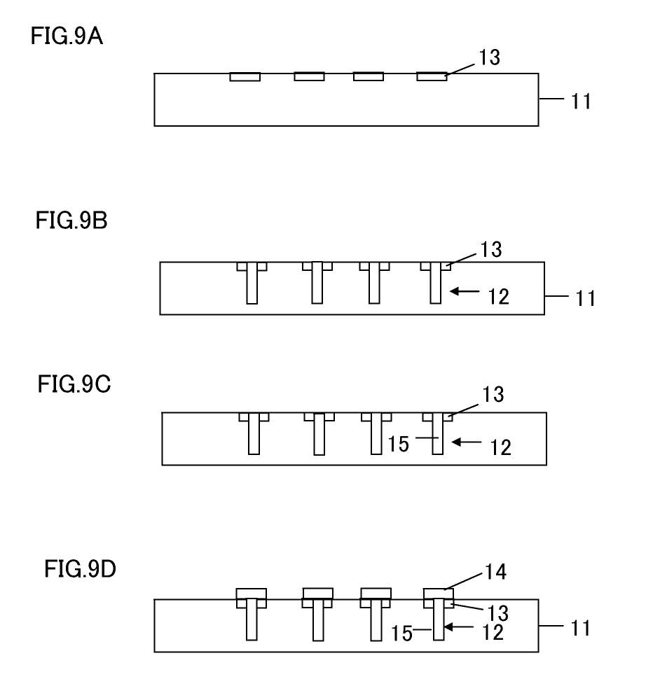

In FIGS. 9A to 9D, diagrams of manufacturing processes of the board according to the second embodiment are illustrated.

(a) A printed circuit board 11 on which the board electrodes 13 has been formed in advance is prepared (refer to FIG. 9A).

(b) Then, the joining member accommodation holes 12 are formed from the center of the board electrodes 13 toward the vertical direction by a drill (refer to FIG. 9B).

(c) Next, the thermal expansion material 15 is injected into each of the joining member accommodation holes 12 by a dispenser down to a distance of 2.18 mm from the bottom of the joining member accommodation holes 12 (refer to FIG. 9C).

(d) Thereafter, the printing solder 14 is applied to the board electrodes 13, using a metal mask and a squeegee each having openings corresponding to the board electrodes 13 (refer to FIG. 9D).

### Third Embodiment

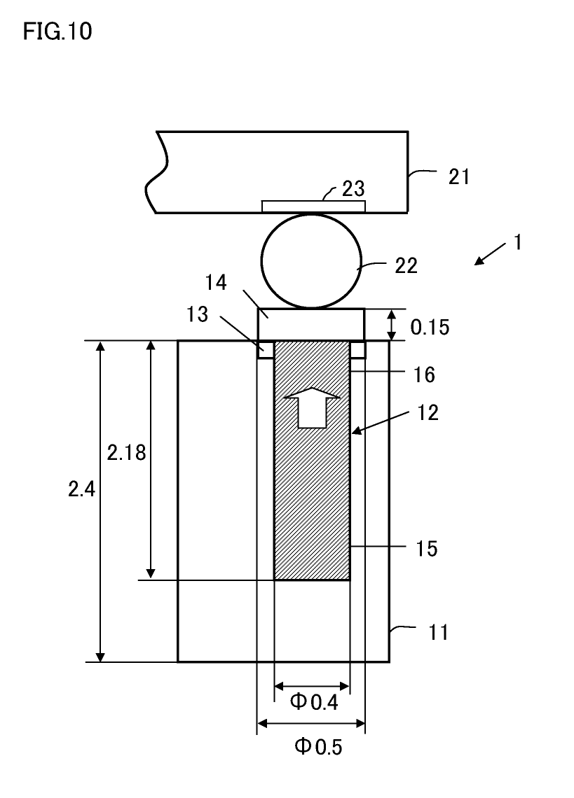

FIG. 10 is an explanatory view of a board unit 1 according to a third embodiment. The board unit 1 includes the electronic component 21 and the printed circuit board 11. FIG. 10 illustrates a state of the board unit 1 before being subjected to reflow.

(1) Description of Structure of Board:

In FIG. 10, a partially enlarged section of one portion of the printed circuit board 11 is illustrated. The printed circuit board 11, the joining member accommodation holes 12, the board electrodes 13, and the printing solder 14 in this embodiment are the same as those in the first embodiment.

The third embodiment is different from the first embodiment in that, as the joining member, only the filling solder 16 is accommodated in each of the joining member accommodation holes 12. The filling solder 16 is Sn—Ag—Cu-based solder having a melting point of 220° C. The filling solder 16 has a diameter of 0.4 mm and a height of 2.18 mm thus occupying a volume of 0.27 mm³. The flux content of the filling solder 16 is about 16 weight percent. Here, it is assumed that the entire flux change into air due to its thermal expansion.

(2) Description of Electronic Component:

The structure of the electronic component 21 in this embodiment is the same as that in the first embodiment. Here shown is an example wherein, for example, a gap of 0.3 mm occurs in the joining between the electronic component 21 and the printed circuit board 11 due to a difference in thermal expansion therebetween. In order to fill the gap, the joining member accommodation holes 12 are disposed at places where joining failure to occur, to thereby perform reinforcement of the joining. The joining member accommodation holes 12 accommodate the filling solder 16. As a result, by the expansion of air formed by flux contained in the filling solder 16, the filling solder 16 is pushed up and merges with the printing solder 14, to thereby join with the solder balls 22 on the electronic component 21.

(3) Description of Joining Processing:

(a) First, the electronic component 21 is mounted onto the printing solder 14 on the board electrodes 13 of the printed circuit board 11 while being aligned with the printing solder 14 using the solder balls 22.

(b) The solder balls 22 on the electronic component 21 are temporarily adhered to the printed circuit board 11 by the printing solder 14 (step S1 in FIG. 5).

(c) Next, the printed circuit board 11 with the electronic component 21 mounted thereon is put into a reflow furnace (step S2 in FIG. 5)

(d) By performing the heating up to 220° C. in the reflow furnace, the electronic component 21 and the printed circuit board 11 thermally expand, thereby causing warpage to the electronic component 21. As a result, a gap occurs between the solder balls 22 and the printing solder 14. Furthermore, the solder balls 22 and the printing solder 14 melt together.

(e) On the other hand, the flux and the like evaporate due to the thermal expansion, to thereby generate air regions.

(f) The filling solder 16 is pushed up by the expansion of the air regions.

(g) The filling solder 16 pushes up the printing solder 14. The melted filling solder 16 and printing solder 14 merge together to deform into a ball-like shape. The deformed ball-shaped solder assumes a height to fill in the gap of 0.3 mm between the electronic component 21 and the printed circuit board 11, so that the solder balls 22 melted on the electronic component 21 and the printing solder 14 on the printed circuit board 11 join together (step S3 in FIG. 5).

(4) Description of Gap Filling Processing:

Concrete processing for filling the gap of 0.3 mm is described below. (a) The volume percentage of air contained in the filling solder 16 is assumed to be 16%. Hence, the volume of air is: (volume of filling solder 16: 0.27 mm³)×0.16=0.043 mm³. Provided that air is concentrated on the central portion of the joining member accommodation hole 12, when temperature rises from 20° C. up to 220° C., air expands in volume by a factor of {(220+273)/273}/{(20+273)/273}=1.68, on the basis of the Charles's law. Here, it is assumed that the volume be subjected to no influence of atmospheric pressure. Therefore, the expanded amount is: 0.043 mm³×0.68=0.029 mm³

(b) The expanded air pushes out upward the filling solder 16 by a volume of 0.029 mm³.

(c) On the other hand, the volume of the filling solder 16, i.e., 0.029 mm³ plus the volume of the printing solder 14, i.e., 0.029 mm³ is 0.058 mm³. However, since the volume decreases upon melting, the volume of the printing solder decreases, while the volume of the filling solder does not decrease because it has been assumed that air be concentrated on the central portion of the joining member accommodation holes 12. As a consequence, the total volume of 0.058 mm³ becomes 0.046 mm³. On the basis of this volume, the melted solder forms into a ball-like shape due to its surface tension. The height of the top of the ball-shaped solder at this time exceeds 0.3 mm as illustrated in FIG. 6. As a result, the joining between the electronic component 21 and the printed circuit board 11 can be established even though the gap has occurred therebetween.

(5) Description of Manufacturing Processes for Board in Third Embodiment:

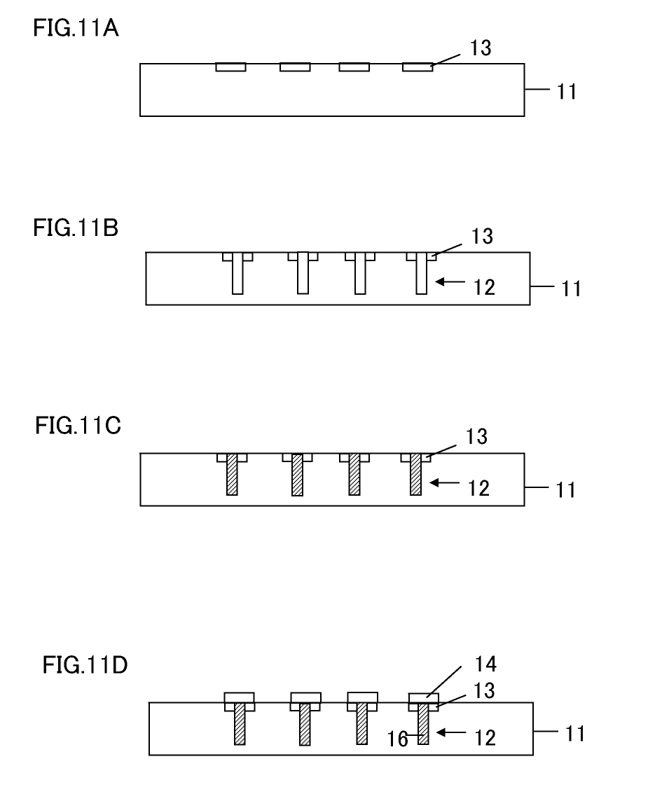

In FIGS. 11A to 11D, diagrams of manufacturing processes of the board according to the third embodiment are illustrated.

(a) A printed circuit board 11 on which the board electrodes 13 has been formed in advance is prepared (refer to FIG. 11A).

(b) Then, the joining member accommodation holes 12 are formed from the center of the board electrodes 13 toward the vertical direction by a drill (refer to FIG. 11B).

(c) Next, the filling solder 16 is filled into the joining member accommodation holes 12, using a metal mask and a squeegee each having openings corresponding to the joining member accommodation holes 12 (refer to FIG. 11C).

(d) Thereafter, the printing solder 14 is applied to the board electrodes 13, using a metal mask and a squeegee each having openings corresponding to the board electrodes 13 (refer to FIG. 11D).

### Fourth Embodiment

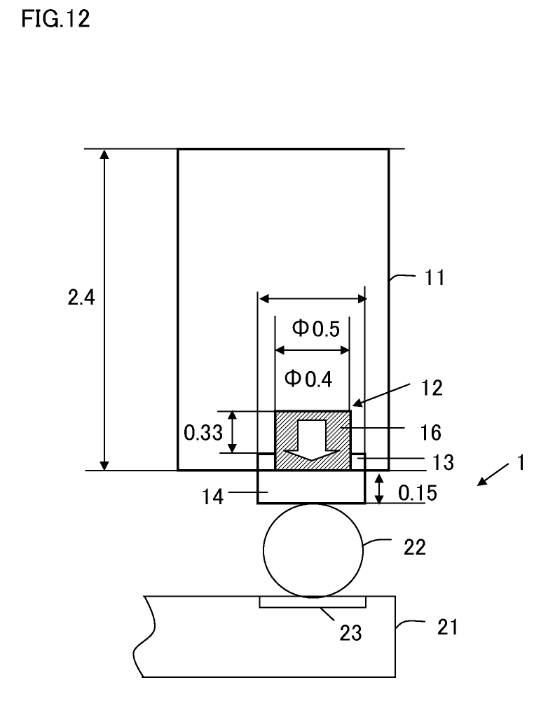

FIG. 12 is an explanatory view of a board unit 1 according to a fourth embodiment. The board unit 1 includes the electronic component 21 and the printed circuit board 11. FIG. 12 illustrates a state of the board unit 1 before being subjected to reflow.

(1) Description of Structure of Board:

In FIG. 12, a partially enlarged section of one portion of the printed circuit board 11 is illustrated. The printed circuit board 11, the board electrodes 13, and the printing solder 14 in this embodiment are the same as those in the first embodiment. The joining member accommodation holes 12 are each a cylindrical hole having, for example, a diameter of 0.4 mm and a depth of 0.33 mm. The joining member accommodation hole 12 is a non-through hole formed from the center of each of the board electrodes 13 toward the inside of the printed circuit board 11. The joining member accommodation holes 12 accommodate the filling solder 16 serving as the joining member. The filling solder 16 is Sn—Ag—Cu-based solder having a melting point of 220° C. The filling solder 16 has a diameter of 0.4 mm and a height of 0.33 mm thus occupying a volume of 0.042 mm³. The flux content of the filling solder 16 is about 12 weight percent.

(2) Description of Electronic Component:

The structure of the electronic component 21 in this embodiment is the same as that in the first embodiment. Here shown is an example wherein, for example, a gap of 0.3 mm occurs in the joining between the electronic component 21 and the printed circuit board 11 due to a difference in thermal expansion therebetween. In order to fill the gap, the joining member accommodation holes 12 are disposed at places where joining failure to occur, to thereby perform reinforcement of the joining. The joining member accommodation holes 12 accommodate the filling solder 16. As a result, the melted filling solder 16 pushes down the printing solder 14 by its own weight to thereby join with the solder balls 22.

(3) Description of Joining Processing:

(a) First, the electronic component 21 is mounted to the printing solder 14 on the board electrodes 13 of the printed circuit board 11 while being aligned with the printing solder 14 using the solder balls 22.

(b) The solder balls 22 on the electronic component 21 are temporarily adhered to the printed circuit board 11 by the printing solder 14 (step S1 in FIG. 5).

(c) A jig is attached to the electronic component 21 and the printed circuit board 11 from above and fixed. On the undersurface of the jig, there are provided pins indicating the centers of the board and the component.

(d) Next, the printed circuit board 11 with the electronic component 21 mounted thereon is turned upside down, and put into the reflow furnace with the jig attached (step S2 in FIG. 5).

(e) By performing the heating up to 220° C. in the reflow furnace, the electronic component 21 and the printed circuit board 11 thermally expand, thereby causing warpage to the electronic component 21. As a result, a gap occurs between the solder balls 22 and the printing solder 14. Furthermore, the solder balls 22, the printing solder 14, and the filling solder 16 each melt.

(f) The melted filling solder 16 drops down under its own weight.

(g) Upon dropping down, the melted filling solder 16 merges with the melted printing solder 14 and deforms into a ball-like shape. The deformed solder ball assumes a height to fill in the gap of 0.3 mm between the electronic component 21 and the printed circuit board 11, so that the solder balls 22 melted on the electronic component 21 and the printing solder 14 join together (step S3 in FIG. 5).

(4) Description of Gap Filling Processing:

Concrete processing for filling the gap of 0.3 mm is described below. The volume of the filling solder 16, i.e., 0.042 mm³ plus the volume of the printing solder 14, i.e., 0.029 mm³ is 0.071 mm³. However, since the volume decreases upon melting, the total volume of 0.071 mm³ decreases to 0.043 mm³. On the basis of this volume, the melted solder forms into a ball-like shape due to its surface tension. The height of its top at this time becomes 0.3 mm as illustrated in FIG. 6. As a consequence, the joining between the electronic component 21 and the printed circuit board 11 can be established even though the gap has occurred therebetween.

(5) Description of Manufacturing Processes for Board in Fourth Embodiment:

The manufacturing processes of the board in the fourth embodiment is the same as those in the third embodiment except for the depth of the joining member accommodation holes 12.

### Fifth Embodiment

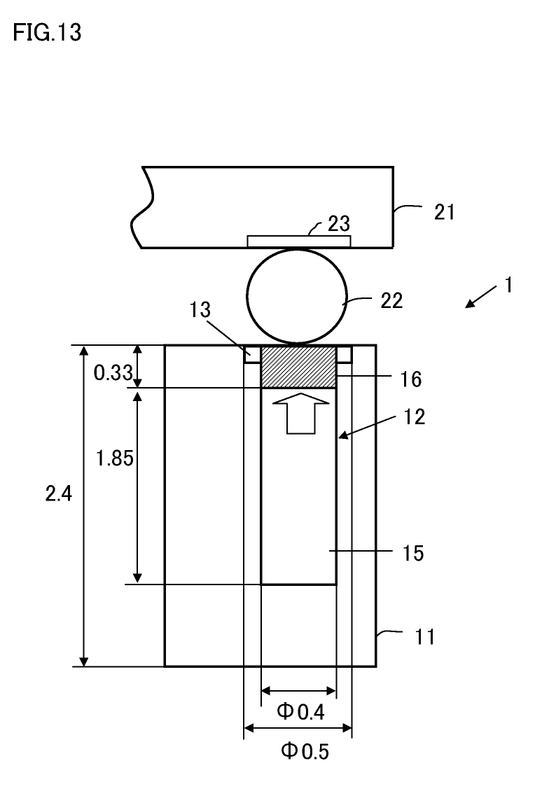

FIG. 13 is an explanatory view of a board unit 1 according to a fifth embodiment. The board unit 1 includes the electronic component 21 and the printed circuit board 11. FIG. 13 illustrates a state of the board unit 1 before being subjected to reflow.

(1) Description of Structure of Board:

In FIG. 13, a partially enlarged section of one portion of the printed circuit board 11 is illustrated. The difference of this embodiment from the first embodiment is only that the printing solder 14 is not provided.

(2) Description of Electronic Component:

The structure of the electronic component 21 in this embodiment is the same as that in the first embodiment. Here shown is an example wherein a gap of 0.21 mm occurs in the joining between the electronic component 21 and the printed circuit board 11 due to a difference in thermal expansion therebetween. In order to fill the gap, the joining member accommodation holes 12 are disposed at places where joining failure to occur, to thereby perform reinforcement of the joining. Each of the joining member accommodation holes 12 accommodates the thermal expansion material 15 in the lower layer portion and the filling solder 16 in the upper layer portion. As a result, the filling solder 16 is pushed up by the expansion of the thermal expansion material 15, and due to its melting, the filling solder 16 joins with the solder balls 22 on the electronic component 21.

(3) Description of Joining Processing:

(a) First, the electronic component 21 is temporarily adhered to the printed circuit board 11 by applying flux to the solder balls 22 on the electronic component 21. For this purpose, preflux function of a component mounter is utilized. The component mounter is operative to suck the electronic component 21 by its nozzles, apply flux to the solder balls 22 with the electronic component 21 being placed in a tray containing flux, and mount the electronic component 21 onto the printed circuit board 11 (step S1 in FIG. 5).

(b) Next, the printed circuit board 11 with the electronic component 21 mounted thereon is put into the reflow furnace (step S2 in FIG. 5).

(c) By performing the heating up to 220° C. in the reflow furnace, the electronic component 21 and the printed circuit board 11 thermally expand. Due to the difference in expansion between the electronic component 21 and the printed circuit board 11, warpage occurs in the electronic component 21, to thereby causing a gap between the solder balls 22 and the board electrodes 13. Furthermore, the solder balls 22 and the filling solder 16 melt together.

(d) On the other hand, the thermal expansion material 15 increases in volume due to its thermal expansion, to thereby push up the filling solder 16.

(e) The pushed-up filling solder 16 deforms into a ball-like shape due to melting.

(f) The deformed ball-shaped solder assumes a height to fill in the gap between the electronic component 21 and the printed circuit board 11, so that the melted solder balls 22 on the electronic component 21 and the printing solder 14 join together (step S3 in FIG. 5).

(4) Description of Gap Filling Processing:

Because the structure of the printed circuit board 11 in this embodiment is similar to that in the first embodiment, the volume of the pushed-out filling solder 16 is 0.042 mm³. In this case, the volume of the filling solder 16 in a melted state is 0.025 mm³. The height of the ball-shaped filling solder 16, of which the volume is 0.025 mm³, is 0.21 mm as illustrated in FIG. 6. As a result, even though the gap of 0.021 mm has occurred due to the warpage of the electronic component 21, the joining between the electronic component 21 and the printed circuit board 11 can be established.

(5) Description of Manufacturing Processes for Board in Fifth Embodiment:

The manufacturing processes of the board in the fifth embodiment differ from the first embodiment only in that processes for the printing solder 14 are not included.

### Sixth Embodiment

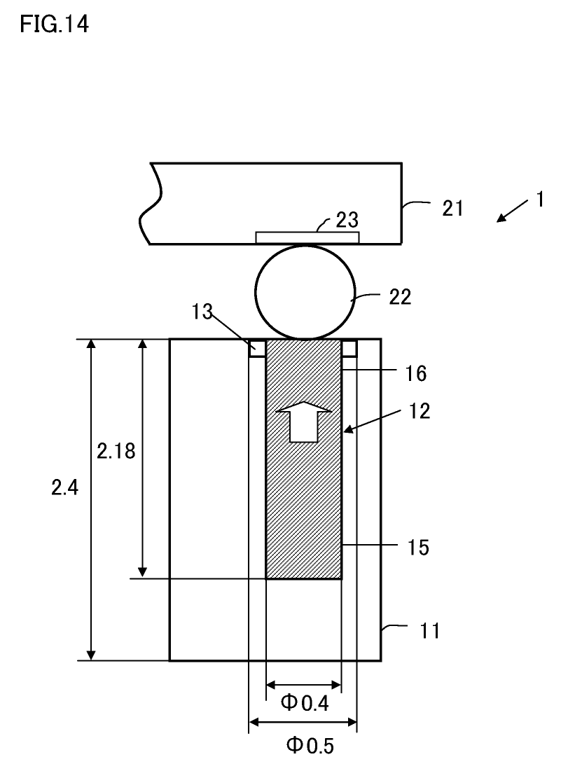

FIG. 14 illustrates a board unit 1 according to a sixth embodiment.

The board unit 1 includes the electronic component 21 and the printed circuit board 11. FIG. 14 illustrates a state of the board unit 1 before being subjected to reflow.

(1) Description of Structure of Board:

In FIG. 14, a partially enlarged section of one portion of the printed circuit board 11 is illustrated. The difference of this embodiment from the third embodiment is only that the printing solder 14 is not provided.

(2) Description of Electronic Component:

The structure of the electronic component 21 is the same as that in the first embodiment. Here shown is an example wherein a gap of 0.21 mm occurs in the joining between the electronic component 21 and the printed circuit board 11 due to a difference in thermal expansion therebetween. In order to fill the gap, the joining member accommodation holes 12 are disposed at places where joining failure to occur, to thereby perform reinforcement of the joining. The joining member accommodation holes 12 accommodate the filling solder 16. As a result, the filling solder 16 is pushed up by the expansion of air formed by flux in the filling solder 16, to join with the solder balls 22 on the electronic component 21.

(3) Description of Joining Processing:

(a) First, the electronic component 21 is temporarily adhered to the printed circuit board 11 by applying flux to the solder balls 22 on the electronic component 21. For this purpose, preflux function of a component mounter is utilized. The component mounter is operative to suck the electronic component 21 by its nozzles, apply flux to the solder balls 22, with the electronic component 21 being placed in a tray containing flux, and mount the electronic component 21 onto the printed circuit board 11 (step S1 in FIG. 5).

(b) Next, the printed circuit board 11 with the electronic component 21 mounted thereon is put into the reflow furnace (step S2 in FIG. 5).

(c) By performing the heating up to 220° C. in the reflow furnace, the electronic component 21 and the printed circuit board 11 thermally expand, thereby causing warpage to the electronic component 21. As a result, a gap occurs between the solder balls 22 and the board electrodes 13. Furthermore, the solder balls 22 and the filling solder 16 melt together.

(d) On the other hand, in the filling solder 16, due to its thermal expansion, flux and the like evaporate, to thereby generate air regions.

(e) By the expansion of the air regions, the filling solder 16 is pushed up.

(f) The melted filling solder 16 deforms into a ball-like shape. This ball-shaped filling solder 16 fills the gag between the electronic component 21 and the board electrodes 13 on the printed circuit board 11, to thereby join the electronic component 21 and the printed circuit board 11 together.

(4) Description of Gap Filling Processing:

When the structure of the printed circuit board 11 is the same as that of the third embodiment except for the printing solder 14, the volume of the pushed-out filling solder 16 is 0.029 mm³. The height of the ball-shaped filling solder 16, of which the volume is 0.029 mm³, is 0.23 mm as illustrated in FIG. 6. As a result, even though the gap of 0.021 mm has occurred due to the warpage of the electronic component 21, the joining between the electronic component 21 and the printed circuit board 11 can be established.

(5) Description of Manufacturing Processes for Board in Sixth Embodiment:

The manufacturing processes of the board in the sixth embodiment differ from the third embodiment only in that processes for the printing solder 14 are not included. As described above, the board unit 1 allows the joining between the electronic component 21 and the printed circuit board 11 even if warpage occurs in the electronic component 21. Furthermore, even if the printing solder 14 is not provided as in the case of the fifth embodiment and the sixth embodiment, the electronic component 21 can be mounted onto the printed circuit board 11.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A board unit comprising:
an electronic component having an electrode;
a printed circuit board having a board electrode disposed at a position corresponding to the electrode, and mounting the electronic component;
a recess arranged from the center of the board electrode toward the inside of the printed circuit board; and
a joining member filled in the recess, and projecting from the board electrode upon being heated.

2. The board unit according to claim 1, further comprising:
a solder member that is provided between the board electrode and the electrode, and that is pushed up in a direction of the electrode by the projection of the joining member.

3. The board unit according to claim 1, wherein the joining member is solder.

4. The board unit according to claim 2, wherein the joining member is solder.

5. The board unit according to claim 2, wherein the joining member is a thermal expansion material.

6. The board unit according to claim 1, wherein the joining member is composed of the solder and the thermal expansion material.

7. The board unit according to claim 2, wherein the joining member is composed of the solder and the thermal expansion material.

8. A manufacturing method for a board unit, the method comprising:
forming a recess in the central portion of a board electrode on a printed circuit board, the board electrode being disposed at a position corresponding to an electrode of an electronic component;
filling a joining member in the recess; and
applying printing solder to the topside of the recess.
